(19) United States
(12) Patent Application Publication
(10) Pub. No.: US 2004/0176495 A1
(43) Pub. Date: Sep. 9, 2004

(54) Raw composition for preparing polyurethane foam having improved adhesive and demolding properties, polyurethane foam made therefrom, and preparation method thereof

(75) Inventors: Beung-Choul You, Gyeongsangnam-Do (KR); Ju-Hyun Kim, Gyeongsangnam-Do (KR)

Correspondence Address: FLESHNER & KIM, LLP, P.O. BOX 221200, CHANTILLY, VA, 20153, US

(73) Assignee: LG Electronics Inc.

(21) Appl. No.: 10/793,833

(22) Filed: Mar. 8, 2004

(30) Foreign Application Priority Data
Mar. 7, 2003 (KR) 14424/2003

(51) Int. Cl. C08G 18/00; C08J 9/00

(52) U.S. Cl. 521/170

(57) ABSTRACT

In a composition for rigid polyurethane foam, polyurethane foam made therefrom and a preparation method thereof, by using an appropriate composition comprising polyol with a high functional group, a catalyst and a blowing agent, polyurethane foam having improved demolding and adhesive properties can be fabricated. In addition, in order to solve problems according to viscosity rise of a composition caused by polyol with a high functional group, a discharging temperature is adjusted in discharging of a raw composition to improve compatibility of ingredients and polyurethane foam having better properties can be obtained.

### BACKGROUND OF THE INVENTION

1. Field of the Invention

The present invention relates to a raw composition for polyurethane foam, polyurethane foam made therefrom and a preparation method thereof. In particular, the present invention relates to a raw composition comprising polyol(s) with high functional group, a catalyst and a blowing agent to-prepare polyurethane foam having improved demolding and adhesive properties, polyurethane foam made therefrom, and a preparation method thereof.

2. Description of the Related Art

In general, a rigid polyurethane foam can be obtained by reacting a polyol with an isocyanate in the presence of a reactive catalyst, a blowing agent and a foam stabilizer. Because the polyurethane foam has a good adiabatic property, it is largely used for a refrigerator, a freezing container and a low-temperature warehouse, etc., which are required to have a high adiabatic property. In use of the refrigerator, etc., polyurethane foam is performing not only a function as a heat insulating material but also a function for maintaining a strength of a REF′ (triple conjugate of ABS resin/polyurethane/steel plate). In order for a rigid polyurethane foam to perform a function for maintaining a strength of REF′, it is important that the rigid polyurethane foam has an excellent adhesive strength with other materials constructing a shape of a REF′. In addition, in the production of a REF′, besides the adhesive strength, a demolding property of the polyurethane foam is also very important. The adhesive strength allows to maintain an optimum temperature of materials constructing a shape of the RE′ and a jig for maintaining the shape, to maximize a property of polyurethane foam. In addition, the demolding is aging in a fixed frame of the jig at a specific temperature for a specific time, and productivity of a REF′ depends on the reduction of a demolding time.

Properties of polyurethane foam including the adhesive and demolding properties are greatly influenced by ingredients and a composition of polyurethane foam. Accordingly, in order to obtain polyurethane foam having excellent properties, ingredients and their composition ratio in a raw composition for preparing polyurethane foam are very important. In the conventional art, polyurethane foam has various properties evenly, or the ingredients of the polyurethane foam and/or the composition ratio thereof are varied to obtain an effect of a specific factor. Depending on a property intended to be improved, ingredients and a composition ratio of polyurethane foam can be varied, and accordingly general properties of polyurethane foam can be varied.

In the present invention, in order to maximize demolding and adhesive properties, polyol with a high viscosity is used in preparing a raw composition. In order to solve several problems caused by using polyol with a high viscosity, an appropriate blowing agent is selected and operating conditions are changed, to lower a viscosity of a raw composition.

### SUMMARY OF THE INVENTION

It is an object of the present invention to provide a raw composition comprising properly selected ingredients and a properly adjusted composition ratio therebetween to prepare polyurethane foam having improved demolding and adhesive properties in comparison with those of the conventional polyurethane foam, and a preparation method thereof wherein the operating conditions are properly adjusted.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a method for measuring an adhesive strength of polyurethane foam;

FIGS. 2a-2d illustrate results of an adhesive strength measured from Example of the present invention and Comparative Examples 1-3 (material: Galva, temperature: 40° C.) by the method in FIG. 1;

FIG. 3 illustrates a method for measuring a demolding property of polyurethane foam; and

FIG. 4 illustrates demolding properties measured by the method in FIG. 3.

### DETAILED DESCRIPTION OF THE PREFERRED EMBODIMENT

The present invention relates to a raw composition for rigid polyurethane foam, polyurethane foam made therefrom, and a preparation method thereof. In more detail, the present invention relates to a raw composition comprising polyol(s) with high functional group, a catalyst and a blowing agent in an appropriate composition ratio to prepare polyurethane foam having improved demolding and adhesive properties. In addition, in order to solve problems according to an increased viscosity of a raw composition caused by using polyols with a high functional group, the present invention provide a method for preparing polyurethane foam, wherein the miscibility of ingredients in the discharged raw composition is improved by changing a discharge temperature of the raw composition, to obtain polyurethane foam having better properties.

First, the present invention relates to a raw composition for preparing rigid polyurethane to improve properties of rigid polyurethane, which is affecting productivity foam, such as a demolding property and an adhesive strength. In more detail, a raw composition for polyurethane foam according to the present invention includes a mixed polyol 100 weight parts, isocyanate 150-180 weight parts, catalyst A 0.1-2.0 weight parts, catalyst B 0.1-0.5 weight parts, catalyst C 0.1-0.5 weight parts, water 3.0-6.0 weight parts, HCFC-141b 10-50 weight parts and surface-active agent 1.0-4.0 weight parts;

The mixed polyol consists of polyol A 50-60 weight parts prepared by polymerization of an organic oxide by using sorbitol with a hexa-valent functional group as an initiator; polyol B 20-30 weight parts prepared by polymerization of an organic oxide by using toluene diamine (TDA) with tetra-valent functional group as an initiator; polyol C 5-20 weight parts prepared by polymerization of an organic oxide by using sucrose with an octa-valent functional group and glycerine with a tri-valent functional group as a mixed initiator; and polyol D 3-10 weight parts prepared by polymerization of an organic oxide by using ethylene diamine (EDA) with a tetra-valent functional group as an initiator.

The catalyst A is a mixture of a gelling catalyst and a blowing catalyst, the catalyst B is a gelling catalyst, and the catalyst C is a trimerization catalyst.

The ingredients will be described in detail as following.

Polyol

Polyol is a raw material for forming a basic skeleton of a polyurethane structure, polyol is used in the mixed form of base polyols according to various purposes, and polyurethane shows different properties depending on ingredients of the mixed polyol. Most of polyol used in the urethane industry is polyhydric alcohol having an ether structure (C—O—C), which is obtained by polymerizing an organic oxide by using at least two active hydrogens as an initiator.

In the meantime, in the present invention, besides basic properties, in order to improve demolding and adhesive properties affecting productivity, a mixed polyol obtained by mixing specific polyol ingredients (polyol A, B, C, D) in a specific composition ratio is used.

In the present invention, polyol A is prepared by polymerization of an organic oxide by using sorbitol with a hexa-valent functional group as an initiator, polyol B is prepared by polymerization of an organic oxide by using TDA with a tetra-valent functional group as an initiator, polyol C is prepared by polymerization of an organic oxide by using sucrose with an octa-valent functional group and glycerine with a tri-valent functional group as a mixed initiator, and polyol D is prepared by polymerization of an organic oxide by using EDA with a tetra-valent functional group as an initiator.

The mixed polyol in the present invention consists of polyol A 50-60 weight parts, polyol B 20-30 weight parts, polyol C 5-20 weight parts and polyol D 3-10 weight parts. The composition according to the present invention comprises the above-described mixed polyol in the amount of 100 weight parts.

Besides, for the purpose of comparison with the present invention, in Comparative Examples, polyol E prepared by polymerization of an organic oxide by using ester with a bi-valent functional group as an initiator and polyol F prepared by polymerization of an organic oxide by using glycerine with a tri-valent functional group as an initiator are additionally used.

Isocyanate

Organic isocyanate is an organic compound containing isocyanate (—NCO) on a molecule and is a main ingredient forming a basic skeleton structure of polyurethane together with polyol in preparation of polyurethane. Organic isocyanates generally used in preparing polyurethane can be used in the present invention. For example, diphenylmethane diisocyanate (polymeric MDI) or toluene diisocyanate (TDI) and so on can be used, and more preferably, MDI can be used.

MDI (Diphenylmethane Diisocyanate)

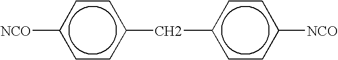

TDI (Toluene Diisocyanate)

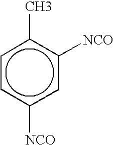

In order to prepare optimum foam, it is preferable for isocyanate to have a NCO/OH index in the range of approximately 1.0 to 1.2. In the present invention, isocyanate is used in the amount of approximately 150 to 180 weight parts on the basis of mixed polyol 100 weight parts. When isocyanate less than that range is used, it is difficult to form polyurethane foam, when isocyanate exceeding that range is used, a low-temperature dimensional stability may be lowered and a clumbles of foam may occur.

Catalyst

A catalyst reduces a reaction time in forming of foam by adjusting reactivity of polyurethane foam, and adjusts flowability of foam in rising of the foam. A catalyst used in the present invention can be largely divided into a blowing catalyst, a gelling catalyst and a trimerization catalyst. The amount of a catalyst has to be appropriately adjusted according to a shape and a structure of a refrigerator to be produced.

The gelling catalyst affects reactivity of foam, attacking isocyanate (e.g., MDI) and reacting the isocyanate with polyol to prepare polyurethane resin. Examples of the gelling catalyst include N,N-dimethyl cyclohexyl amine (DMCHA), tri-methylene hexane diamine (TMHDA), tri-ethylene diamine (TEDA), etc. The blowing catalyst serves to facilitate a reaction between isocyanate to supply heat required for foaming, and accelerate polyol and MDI to make a resinification reaction. Representative foaming catalyst is a pentamethylene diethylene triamine (PMDETA), BDMEE, etc. The trimerization catalyst for accelerating trimerization reaction for forming isocyanurate trimer by reacting three isocyanate, and some tertiary amine or some organic metal based catalyst can be used as the trimerization catalyst. For example, quaternary ammonium salt, 2,4,6-tris-(Dimethylaminomethyl)penol, etc. can be used as the trimerization catalyst can be used as the trimerization catalyst.

In the embodiment of the present invention, the catalyst A, the catalyst B and the catalyst C are used, and they will be described in detail as following.

The catalyst A is a mixture of a gelling catalyst and a blowing catalyst. In the present invention, the catalyst A is obtained by mixing TMHDA as a gelling catalyst and PMDETA as a blowing catalyst in the weight ratio of 3:1 and used in the amount of 0.1 to 2.0 weight parts on the basis of the mixed polyol 100 weight pars.

The catalyst B is a strong gelling catalyst affecting reactivity of foam. In the present invention, TEDA is used as the catalyst B in the amount of 0.1 to 0.5 weight parts on the basis of the mixed polyol 100 weight parts.

The catalyst C is a trimerization catalyst. In the present invention, 2,4,6-tris-(Dimethylaminomethyl)phenol (for example, TMR-2™, TMR-13™, TR-52™, KAO-14™, etc.) is used as the catalyst C in the amount of 0.1 to 0.5 weight parts on the basis of the mixed polyol 100 weight parts.

2,4,6-tris-(Dimethylaminomethyl)phenol

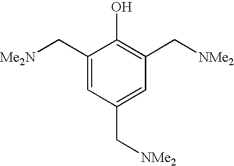

For comparison with the present invention, in Comparative Example, a catalyst D (for example, KAO™ or PC-LG™, etc.) obtained by mixing DMCHA as a strong gelling catalyst and PMDETA as a blowing catalyst in the ratio of 1:1; a catalyst E (for example, TMF™, etc.) functioning as an acid block type blowing catalyst and affecting early reactivity to generate lots of CO₂; and a catalyst F obtained by mixing DMCHA and PMDETA in the ratio of 3:1 are additionally used.

Blowing Agent

In the present invention, water as a chemical blowing agent and dichloromonofluoroethane (HCFC-141b) as a physical blowing agent are used. Water used as a chemical blowing agent generates CO₂ gas by reacting with isocyanate (MDI), and HCFC-141B used as a physical blowing agent is gasified at a temperature not less than the boiling point (32.8° C.). In the present invention, on the basis of mixed polyol 100 weight parts, it is preferable to use water in the amount of 3.0 to 6.0 weight parts and HCFC-141b in the amount of 10 to 50 weight parts.

Surface-Active Agent

In the composition for rigid polyurethane foam according to the present invention, a surface-active agent is optionally used, and a silicon surface-active agent generally used in preparing rigid polyurethane foam can be used. The surface-active agent is for forming a cell and increasing compatibility of polyol and the blowing agent. In the present invention, the surface-active agent reduces a surface tension to improve miscibility, uniformizes a size of generated pores and adjusts a pore structure of the foam to stabilize the generated foam. In the present invention, when using silicon surface-active agent, the amount of a surface-active agent is in the range of approximately 1.0 to 4.0 weight parts on the basis of mixed polyol 100 weight parts.

In the present invention, by improving the degree of cross-linking between polyols by using polyol with a high functional group, a cell structure of polyurethane foam can be strengthened, and demolding property of polyurethane foam can be improved. In addition, by increasing the dosage of polyol with a high functional group, an adhesive strength of polyurethane foam can be increased.

In addition, the present invention provides a preparation method of a raw composition for obtaining polyurethane foam having improved demolding and adhesive properties, comprises the steps of;

preparing mixed polyol by sufficiently mixing 50-60 weight parts of polyol A prepared by polymerization of an organic oxide by using sorbitol with a hexa-valent functional group, 20-30 weight parts of polyol B prepared by polymerization of an organic oxide by using TDA with a tetra-valent functional group as an initiator, 5-20 weight parts of polyol C prepared by polymerization of an organic oxide by using sucrose with a octa-valent functional group and glycerine with a tri-valent functional group as a mixed initiator and 3-10 weight parts of polyol D prepared by polymerization of an organic oxide by using EDA with a tetra-valent functional group as an initiator; and

sufficiently mixing the obtained mixed polyol 100 weight parts, isocyanurate 150-180 weight parts, water 3.0-6.0 weight parts, HCFC-141b 10 -50 weight parts, 0.1-2.0 weight parts of a mixed catalyst A obtained by mixing a gelling catalyst and a blowing catalyst, a gelling catalyst B 0.1-0.5 weight parts, a trimerization catalyst C 0.1-0.5 weight parts and a surface-active agent 1.0-4.0 weight parts.

Ingredients used in the above preparation method are the same with the above-mentioned ingredients.

In addition, the present invention provides polyurethane foam having improved demolding and adhesive properties, obtained by discharging the raw composition according to the present invention or prepared by the method of the present invention at a discharge temperature of 29-33° C.

Herein, in the composition of the present invention, thermal conductivity (k value) and viscosity of polyurethane foam tend to rise. In order to solve this problem, unlike the conventional discharge temperature of 26° C. with respect to both a R (resin; mixture of polyol, water, catalysts, a surface-active agent and a blowing agent) solution and a P (pure; comprising isocyanate as a single ingredient) solution, in the present invention, the discharge temperature of the R solution is adjusted at 31±2° C., namely, 29° C.-33° C. to lower a viscosity of the R solution (having a high viscosity), and to improve the miscibility of ingredients in preparing polyurethane foam. In addition, in order to make the raw composition have the same reactivity with that of the conventional art after discharged at the adjusted temperature, the amount of a catalyst is determined as mentioned above. Further, in order to adjust a minute increase of a K value due to usage of polyol with a high functional group, the amount of a gelling catalyst is slightly increased to obtain equilibrium of properties.

Hereinafter, the present invention will be described in detail with reference to accompanying examples. However, the present invention is not limited by following examples.

### EXAMPLE

Polyol A 50-60 weight parts, polyol B 20-30 weight parts, polyol C 5-20 weight parts and polyol D 3-10 weight parts were mixed to prepare a mixed polyol 100 weight parts. On the basis of the mixed polyol 100 weight parts, water 3.0-6.0 weight parts, HCFC-141b 10-50 weight parts, a catalyst A 0.1-2.0 weight parts in which TMHDA and PMDETA are mixed as 3:1, a catalyst B (TEDA) 0.1-0.5 weight parts and a catalyst C 0.1-0.5 weight parts, a silicon surface-active agent 1.0-4.0 weight parts and MDI 150-180 weight parts were added to the mixed polyol and mixed to prepare a raw composition for rigid polyurethane foam. The obtained composition was foamed and hardened to obtain a sample of rigid polyurethane foam. Herein, in order to show properties of each ingredient as they are, the ingredients have to be sufficiently mixed.

### Comparative Example 1

Polyol A 50-60 weight parts, polyol B 20-30 weight parts, polyol E 0-10 weight parts and polyol F 10-20 weight parts were mixed to prepare a mixed polyol 100 weight parts. On the basis of the mixed polyol 100 weight parts, water 3.0-6.0 weight parts, HCFC-141b 10-50 weight parts, a catalyst C 0.1-0.5 weight parts, a catalyst D 0.1-2.0 weight parts, a silicon surface-active agent 1.0-4.0 weight parts and MDI 150-180 weight parts were added to the mixed polyol and mixed to prepare a raw composition for rigid polyurethane foam. The obtained composition was foamed and hardened to obtain a sample of rigid polyurethane foam.

### Comparative Example 2

Polyol A 40-60 weight parts, polyol B 30-50 weight parts, polyol D 0-20 weight parts and polyol E 0-10 weight parts were mixed to prepare a mixed polyol 100 weight parts. On the basis of the mixed polyol 100 weight parts, water 3.0 -6.0 weight parts, HCFC-141b 10-50 weight parts, a catalyst C 0.1-0.5 weight parts, a catalyst D 0.1-2.0 weight parts, a silicon surface-active agent 1.0-4.0 weight parts and MDI 150-180 weight parts were added to the mixed polyol and mixed to prepare a raw composition for rigid polyurethane foam. The obtained composition was foamed and hardened to obtain a sample of rigid polyurethane foam sample.

### Comparative Example 3

Polyol A 40-50 weight parts, polyol B 30-40 weight parts, polyol E 0-20 weight parts and polyol F 20-30 weight parts were mixed to prepare a mixed polyol 100 weight parts. On the basis of the mixed polyol 100 weight parts, water 3.0-6.0 weight parts, cyclopentane (C/Pentane) 10-20 weight parts, a catalyst C 1.0-3.0 weight parts, a catalyst E 0.1-1.0 weight parts, a catalyst F 0.1-0.5 weight parts, a silicon surface-active agent 1.0-4.0 weight parts and MDI 140-170 weight parts were added to the mixed polyol and mixed to prepare a raw composition for rigid polyurethane foam. The obtained composition was foamed and hardened to obtain a sample of rigid polyurethane foam sample.

Following Table 1 shows representative examples of each ingredient and composition ratio of polyurethane foam compositions used in Example and Comparative Examples. The most important thing is ingredients and composition ratio of the mixed polyol, and the amount of other ingredients except polyol is calculated on the basis of mixed polyol 100 weight parts.

In addition, properties of polyurethane foam obtained from a composition of Example and Comparative Examples are shown in following Table 2. Because errors may occur in measuring of properties, properties are shown as a limited range.

TABLE 1

| | | | | | | | | C/Pentane |
|---|---|---|---|---|---|---|---|---|
| | | HCFC-141b group | | | | | | group |
| Ingredients | | | | | | Comparative | Comparative | Comparative |
| (Unit: Weight parts) | | Example 1 | Example 2 | Example 3 | Example 4 | Example 1 | Example 2 | Example 3 |
| Polyol | Polyol A | 60 | 59 | 58 | 57 | 60 | 50 | 45 |
| | Polyol B | 20 | 21 | 22 | 23 | 25 | 30 | 30 |
| | Polyol C | 13 | 13 | 13 | 13 | — | — | — |
| | Polyol D | 7 | 7 | 7 | 7 | — | 10 | — |
| | Polyol E | — | — | — | — | 5 | 10 | |
| | Polyol F | — | — | — | — | 10 | — | 25 |
| Isocyanate(MDI) | | 169.6 | 169.3 | 169.5 | 169.6 | 161.0 | 162.0 | 152.6 |
| Catalyst | Catalyst A | 1.5 | 1.5 | 1.5 | 1.5 | — | — | — |
| | Catalyst B | 0.2 | 0.2 | 0.2 | 0.2 | — | — | — |
| | Catalyst C | 0.3 | 0.3 | 0.3 | 0.3 | 0.3 | 0.3 | 0.3 |
| | Catalyst D | — | | | | 1.35 | 1.2 | — |
| | Catalyst E | — | | | | — | — | 2.2 |
| | Catalyst F | — | | | | — | — | 0.5 |
| Foam- | Water | 2.2 | 2.2 | 2.1 | 2.0 | 2.1 | 2.0 | 2.1 |
| ing | HCFC-141b | 34 | 34 | 33 | 33 | 33 | 33 | — |
| Agent | C/Pentane | — | | | | — | — | 14 |

| | | | | | | | |
|---|---|---|---|---|---|---|---|
| Silicon Surface | 2.0 | 2.0 | 2.0 | 2.0 | 2.0 | 2.0 | 2.0 |
| Active Agent | | | | | | | |

TABLE 2

| | | Comparative | Comparative | Comparative |
|---|---|---|---|---|
| Properties | Example 1-4 | Example 1 | Example 2 | Example 3 |
| Core Density (kg/m²) | 27.0-30.0 | 27.0-30.0 | 27.0-30.0 | 29.0-32.0 |
| Dosage (Just Pack, g) | 450-500 | 450-500 | 450-500 | 480-520 |
| Compression Strength | 1.3-2.5 | 1.3-2.5 | 1.3-2.5 | 1.3-2.5 |
| (kg/cm², 25° C.) | | | | |
| k-factor | 0.0140-0.0160 | 0.0140-0.0160 | 0.0140-0.0160 | 0.0150-0.0170 |
| (kcal/m.hr. ° C.) | | | | |
| Demolding Property (%) | 1.0-2.0 | 1.8-3.0 | 1.8-3.0 | 1.0-2.0 |
| Adhesive Strength | 0.20-0.30 | 0.08-0.15 | 0.10-0.20 | 0.15-0.25 |
| (kg/cm²) | | | | |

Properties in Table 2 were measured by following method.

Dosage (Just Pack): The amount of a raw composition, when the composition is injected into a fixed mold, making the polyurethane foam made therefrom accurately fill the fixed volume, and it is measured by an electronic scale.

k-factor: It is generally displayed as λ, it indicates a thermal conductivity of foam and is measured by using auto-λ.

Core Density: Density of a part at which the outer portion of foam in a specific mold is removed, and the density is measured by using an electronic scale and a size measuring apparatus.

Compression Strength: It means compression strength of foam, and it is measured by using a UTM (Universal Testing Machine).

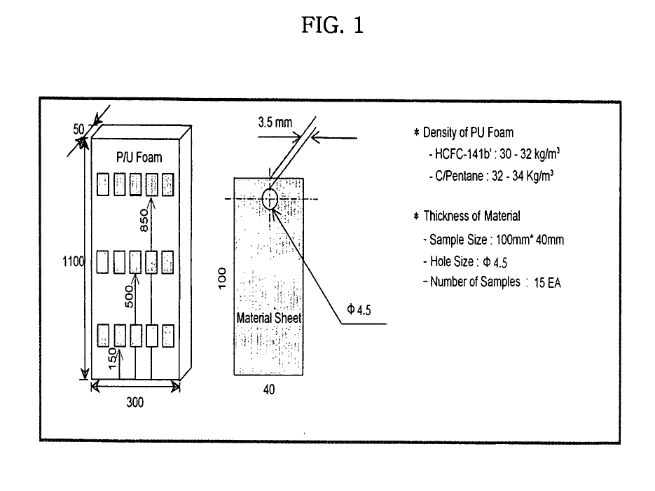

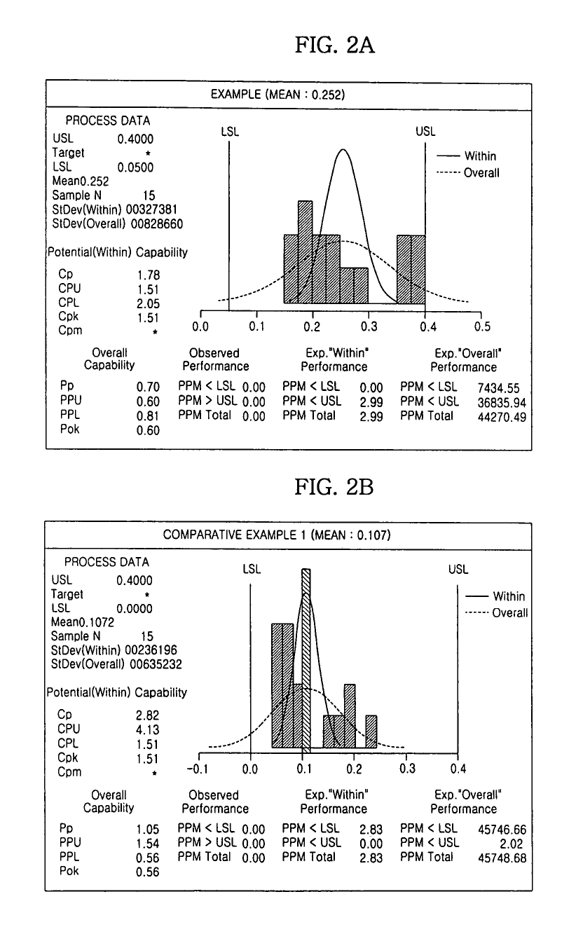

Adhesive Strength: A method for measuring an adhesive strength of polyurethane foam is shown in FIG. 1. A material sample of 100 mm×40 mm having a hole in the size of Φ4.5 is used for an adhesive strength test. (Herein, a Galva material the weakest material among refrigerator materials is used.). Density of polyurethane foam is 30-32 kg/m² in the case of using an HCFC-141b based blowing agent in Example and Comparative Examples 1 and 2, and 32-34 kg/m² in the case of using a C/pentane based blowing agent in Comparative Example 3. The number of samples is 15 respectively. Herein, a material is attached to a Brett mold, and foamed with adjusting the core density of polyurethane foam. The attached sires of the materials are at 150 mm, 500 mm and 850 mm on the basis of the bottom (the total height: 1100 mm). After 5 minutes, the materials were demolded and left at room temperature for an hour, and then, an adhesive strength is determined by measuring the power consumed in separating the material with a push-pull gauge. The measured results show in Table 2 and FIGS. 2A-D. As shown in Table 2 and FIGS. 2A-D, an average value (0.252) in Example of the present invention is superior to each average value (respectively, 0.107, 0.134, 0.161) of Comparative Examples.

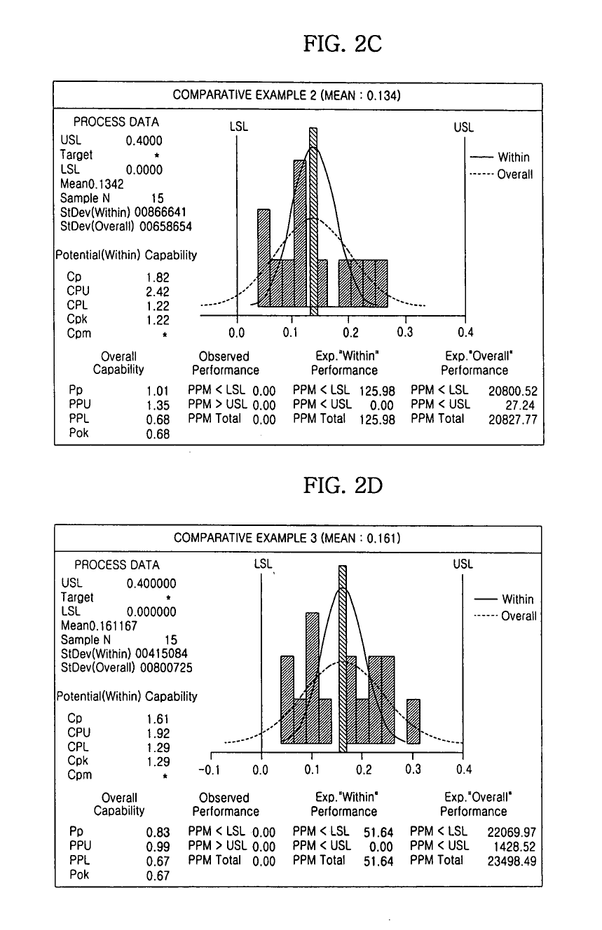

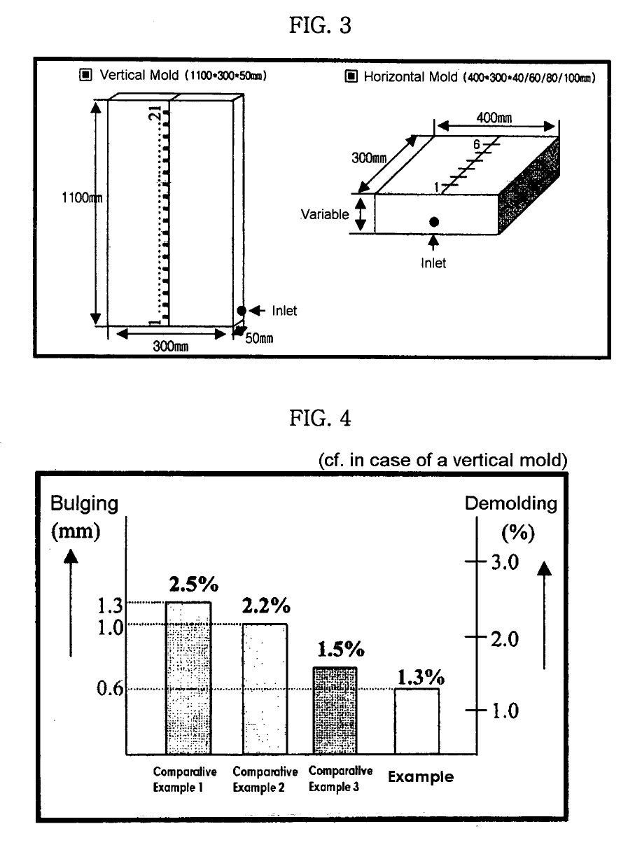

Demolding property; A method for measuring a demolding property of polyurethane foam shows in FIG. 3. Herein, by over packing of 20% to a dosage (Just Packing), size is measured after 4 minutes. In case of a vertical mold, 21 sites at an interval of 50 mm were measured and the result was converted on the basis of 100 mm and, in case of a horizontal mold, six sites from minimum 40 mm to maximum 100 mm were measured, and the result was converted on the basis of 100 mm. The measuring results are shown in Table 2 and FIG. 4. As shown in Table 2 and FIG. 4, a bulging value in Example of the present invention is the lowest, and accordingly Example of the present invention shows the best demolding property.

As shown in Table 2, properties of polyurethane foam can be varied according to a composition thereof, construction of a system can be varied according to a blowing agent, and accordingly an adiabatic property and a dosage can be varied. In the present invention, Example and Comparative Examples 1 and 2 used HCFC-141b as a physical foaming agent, and Comparative Example 3 uses C/Pentane.

As described-above, polyurethane foam in accordance with Example of the present invention does not show many differences in other properties, however it shows a better result in demolding and adhesive properties affecting productivity. The result is supposed to be caused by a foam raw composition. In more detail, in comparison with HCFC-141b system, by improving cross-linking of polyol by using polyol with a high functional group, a cell structure of polyurethane foam is strengthened, and accordingly demolding property is improved. And, by increasing a dosage of high functional group polyol, an adhesive strength is increased. In addition, in order to solve the problem as rise of thermal conductivity and viscosity due to injection of polyol with a high functional group, in the present invention, a discharge temperature of a R solution and content of a catalyst are adjusted appropriately.

In the present invention, by appropriately adjusting ingredients, composition and reaction conditions of a polyurethane raw composition, polyurethane foam having greatly improved demolding and adhesive properties affecting a productivity of foam can be provided while other properties such as flowability, dimensional stability and strength, etc. are almost same with those of the conventional polyurethane foam.

What is claimed is:

1. A composition for preparing polyurethane foam having improved demolding and adhesive properties, comprising:
a mixed polyol 100 weight parts, isocyanate 150-180 weight parts, water 3.0-6.0 weight parts, HCFC-141b 10-50 weight parts, catalyst A 0.1-2.0 weight parts, catalyst B 0.1-0.5 weight parts, catalyst C 0.1-0.5 weight parts and surface-active agent 1.0-4.0 weight parts,
wherein the mixed polyol comprises polyol A 50-60 weight parts prepared by polymerization of an organic oxide by using sorbitol with a hexa-valent functional group as an initiator; polyol B 20-30 weight parts prepared by polymerization of an organic oxide by using TDA with a tetra-valent functional group as an initiator; polyol C 5-20 weight parts prepared by polymerization of an organic oxide by using sucrose with a octa-valent functional group and glycerine with a tri-valent functional group as initiators; and polyol D 3-10 weight parts prepared by polymerization of an organic oxide by using EDA with a tetra-valent functional group as an initiator,
wherein the catalyst A is obtained by mixing a gelling catalyst and a blowing catalyst, the catalyst B is a gelling catalyst, and the catalyst C is a trimerization catalyst.

2. The composition of claim 1, wherein the isocyanate is diphenylmethane diisocyanate (polymeric MDI).

3. The composition of claim 1, wherein the catalyst A is a mixed catalyst comprising TMHDA as a gelling catalyst and MDETA as a blowing catalyst in the ratio of 3:1.

4. The composition of claim 1, wherein the catalyst B is TEDA.

5. The composition of claim 1, wherein the catalyst C is 2,4,6-tris-(Dimethylaminomethyl)phenol.

6. A preparation method of a composition for preparing polyurethane foam having improved demolding and adhesive properties, comprising the steps of:
preparing a mixed polyol by sufficiently mixing polyol A 50-60 weight parts prepared by polymerization of an organic oxide by using sorbitol with a hexa-valent functional group as an initiator, polyol B 20-30 weight parts prepared by polymerization of an organic oxide by using TDA with a tetra-valent functional group as an initiator, polyol C 5-20 weight parts prepared by polymerization of an organic oxide by using sucrose with a octa-valent functional group and glycerine with a tri-valent functional group as initiators, and polyol D 3-10 weight parts prepared by polymerization of an organic oxide by using EDA with a tetra-valent functional group as an initiator; and
sufficiently mixing the obtained mixed polyol 100 weight parts, isocyanate 150-180 weight parts, water 3.0-6.0 weight parts, HCFC-141b 10-50 weight parts, 0.1-2.0 weight parts of mixed catalyst A which is a mixture of a gelling catalyst and a blowing catalyst, gelling catalyst B 0.1-0.5 weight parts, trimerization catalyst C 0.1-0.5 weight parts and surface-active agent 1.0-4.0 weight parts.

7. Polyurethane foam prepared from the composition according to claim 1 adjusting the discharge temperature to the range of 29-33° C.

8. Polyurethane foam prepared from the composition prepared by the method of claim 6 adjusting the discharge temperature to the range of 29-33° C.
